(19) United States
(12) Patent Application Publication
(10) Pub. No.: US 2025/0292092 A1
(43) Pub. Date: Sep. 18, 2025

(54) GENERATIVE OPTIMIZATION MODELS FOR MACHINE LEARNING

(71) Applicants: International Business Machines Corporation, Armonk, NY (US); Massachusetts Institute of Technology, Cambridge, MA (US)

(72) Inventors: Giorgio Giannone, Lyngby (DK); Akash Srivastava, Boston, MA (US); Faez Ahmed, Winchester, MA (US)

(21) Appl. No.: 18/606,107

(22) Filed: Mar. 15, 2024

(51) Int. Cl. G06N 3/084; B29C 64/386; B33Y 50/00; G06N 3/047; G06T 5/60; G06T 5/70; G06T 19/20

(52) U.S. Cl. CPC G06N 3/084; B29C 64/386; B33Y 50/00; G06N 3/047; G06T 5/60; G06T 5/70; G06T 19/20; G06T 2207/30241; G06T 2210/36; G06T 2219/2004; G06T 2219/2021

(57) ABSTRACT

A sample batch is accessed and a conditioning is computed based on given constraints. A dense relaxation is computed based on the computed conditioning and the sample batch to generate kernels for conditioning a diffusion optimization model. A sample is selected from the sample batch based on a randomly sampled timestep and random noise is sampled from a Gaussian distribution. A noisy representation of the selected sample is sampled based on the randomly sampled timestep and the sampled random noise. The diffusion optimization model is run in a forward direction using the noisy representation of the selected sample to generate a prediction. An error loss is computed to minimize an error between the prediction and a target; the target is the sampled random noise. A diffusion optimization loss is computed based on the error loss and the diffusion optimization model is updated based on the diffusion optimization loss using backpropagation.

### STATEMENT REGARDING PRIOR DISCLOSURES BY THE INVENTOR OR A JOINT INVENTOR

The following disclosure(s) are submitted under 35 U.S.C. 102 (b)(1)(A): Giorgio Giannone and Faez Ahmed, Diffusing the optimal topology: A generative optimization approach, arXiv preprint arXiv: 2303.09760, 2023 Mar. 17.

Giorgio Giannone, Akash Srivastava, Ole Winther and Faez Ahmed, Aligning Optimization Trajectories with Diffusion Models for Constrained Design Generation, Advances in Neural Information Processing Systems, 2024 Feb. 13;36, arXiv preprint arXiv: 2305.18470v1 29 May 2023.

### BACKGROUND

The present invention relates generally to the electrical, electronic and computer arts and, more particularly, to artificial intelligence and machine learning.

Deep generative models (DGMs) are exceptionally powerful in generating diverse and unconstrained data, such as images and text, with remarkable diversity and creativity. There is currently a gap in the field of generative models when it comes to integrating optimization techniques to ensure constraint satisfaction and precision in engineering design. This limitation poses challenges in generating designs that meet the required performance metrics and adhere to specific constraints, such as manufacturability, compliance, and volume fraction.

### BRIEF SUMMARY

Principles of the invention provide systems and techniques for generative optimization models for machine learning. In one aspect, an exemplary method includes the operations of accessing a sample batch; computing a conditioning based on given constraints; computing a dense relaxation based on the computed conditioning and the sample batch to generate kernels for conditioning a diffusion optimization model; selecting a sample from the sample batch based on a randomly sampled timestep and sampling random noise from a Gaussian distribution; sampling, based on the randomly sampled timestep, a noisy representation of the selected sample based on the sampled random noise; running the diffusion optimization model in a forward direction using the noisy representation of the selected sample to generate a prediction; computing an error loss to minimize an error between the prediction and a target, where the target is the sampled random noise; computing a diffusion optimization loss based on the error loss; and updating the diffusion optimization model based on the diffusion optimization loss using backpropagation.

In one aspect, a computer program product comprises one or more tangible computer-readable storage media and program instructions stored on at least one of the one or more tangible computer-readable storage media, the program instructions executable by a processor, the program instructions comprising accessing a sample batch; computing a conditioning based on given constraints; computing a dense relaxation based on the computed conditioning and the sample batch to generate kernels for conditioning a diffusion optimization model; selecting a sample from the sample batch based on a randomly sampled timestep and sampling random noise from a Gaussian distribution; sampling, based on the randomly sampled timestep, a noisy representation of the selected sample based on the sampled random noise; running the diffusion optimization model in a forward direction using the noisy representation of the selected sample to generate a prediction; computing an error loss to minimize an error between the prediction and a target, where the target is the sampled random noise; computing a diffusion optimization loss based on the error loss; and updating the diffusion optimization model based on the diffusion optimization loss using backpropagation.

In one aspect, an apparatus comprises a memory and at least one processor, coupled to the memory, and operative to perform operations comprising accessing a sample batch; computing a conditioning based on given constraints; computing a dense relaxation based on the computed conditioning and the sample batch to generate kernels for conditioning a diffusion optimization model; selecting a sample from the sample batch based on a randomly sampled timestep and sampling random noise from a Gaussian distribution; sampling, based on the randomly sampled timestep, a noisy representation of the selected sample based on the sampled random noise; running the diffusion optimization model in a forward direction using the noisy representation of the selected sample to generate a prediction; computing an error loss to minimize an error between the prediction and a target, where the target is the sampled random noise; computing a diffusion optimization loss based on the error loss; and updating the diffusion optimization model based on the diffusion optimization loss using backpropagation.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:

a diffusion optimization model (DOM) that merges data-driven approaches with optimization, using dense relaxation, ex-post optimization, consistency regularization, and cycle consistency mechanisms to handle sparse constraints, improve performance, align sampling and optimization paths, and enhance consistency between optimized and generated configurations;

a diffusion optimization model that, with consistency regularization in accordance with one or more embodiments, incorporates a mechanism that matches intermediate sampling steps with intermediate optimization steps, ensuring close alignment between the generated configurations and the optimized configurations;

a mechanism that enhances the consistency and fidelity of the generated designs with respect to the desired constraints and performance metrics, as the generated configurations follow the same optimization path as the optimized configurations;

techniques to strengthen the alignment between the generative model and the optimization process, resulting in more reliable and accurate generated designs for engineering applications;

a regularization mechanism that injects an optimization-informed prior at each sampling step, forcing it to be close to the corresponding optimization step in terms of distance; a consistency mechanism over the sampling and optimization trajectories;

a significant reduction of the computational cost of generating candidates without sacrificing accuracy;

a trajectory alignment (TA) mechanism (in the training phase) that enables a model to leverage information in the physical trajectory that was used by the optimization-based solution in the training data, drastically cutting down the sampling steps required for a topology;

improvements to inference efficiency, and a reduction in a sampling time for diffusion-based topology generation while still satisfying the design requirements with a minimum decrease in performance;

minimizes reliance on force and strain fields as conditioning information, reducing the computation burden at inference time and the need for ad-hoc conditioning mechanisms for each problem;

a merging of learning-based and optimization-based methods, refining the topology generated using a conditional diffusion model, and improving the final solution in terms of manufacturability and performance;

a DOM that achieves high performance and is at least 50% less computationally expensive at inference time, eliminating the need for finite element method (FEM) preprocessing or additional guidance through surrogate models;

a DOM that outperforms, by a large margin, a conventional generative model for topology with guidance when tasked with generating a new topology given a few steps, corroborating the hypothesis that aligning the sampling and optimization trajectory is an effective mechanism to obtain efficient generative models that satisfy constraints; and

a DOM that outperforms the conventional generative model for topology with guidance (even though being 50% smaller), without leveraging an expensive FEM solver for conditioning but relying on inexpensive dense relaxations, making it 10 to 20 times faster at sampling, and greatly enhancing the quality of the generated designs, providing evidence that trajectory alignment is an effective mechanism to distill information from the optimization path; and

structural topology optimization techniques for optimizing the use of material (e.g., finding optimal shape of a structural member) in a structure under a load with known constraints.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates a conditional diffusion model with additional regression (gr) and classifier (g_{c}) guidance, in accordance with example embodiments;

FIG. 2 illustrates a sparse conditioning field (left-side) and a dense conditioning field (right-side), both used for conditioning a diffusion model, in accordance with example embodiments;

FIG. 3 illustrates the combined approach of combining constrained diffusion model (CDM) candidate generation with optimizer refinement, in accordance with example embodiments;

FIG. 4 illustrates trajectory alignment, in accordance with an example embodiment. Intermediate sampling steps in a diffusion optimization model are matched with intermediate optimization steps;

FIG. 5 a high-level view of topology optimization where the objective is to find the design with the minimum compliance under given loads, boundary conditions (BC), and volume fractions (VF), in accordance with example embodiments;

FIG. 6 is a block diagram of a DOM pipeline with conditioning and kernel relaxation (top left) and trajectory alignment (top right), in accordance with an example embodiment;

FIG. 7 is a graphical report of a visualization of the distance between sampling and optimization trajectory during training, in accordance with an example embodiment;

FIG. 8 shows a comparison of iterative (left), sparse (center), and dense single-step (right) conditioning fields for a constrained diffusion model, in accordance with an example embodiment;

FIG. 9A illustrates a first example training algorithm for DOM with trajectory alignment, in accordance with example embodiments;

FIG. 9B illustrates a second example algorithm for DOM without trajectory alignment, in accordance with example embodiments;

FIG. 9C illustrates an example code listing for dense kernel relaxation for sparse loads, in accordance with example embodiments;

FIG. 9D illustrates a few-step sampling for topology generation, in accordance with example embodiments;

FIG. 10A is a table showing configurations of a comparative study of generative models in topology optimization considering factors like conditional input (COND), finite element method (FEM), and guidance (GUID), in accordance with an example embodiment;

FIG. 10B is a bar graph of confidence intervals for design requirements for in-distribution constraint configurations, in accordance with an example embodiment;

FIG. 10C is a table illustrating results of an evaluation of different model variants on in-distribution constraints, in accordance with an example embodiment;

FIG. 10D is a table illustrating results of evaluating sampling topologies with few steps (2-10) for a conventional generative model for topology and DOM, in accordance with an example embodiment;

FIG. 10E is a table illustrating the results of an out-of-distribution scenario comparison, in accordance with an example embodiment;

FIG. 10F is a table illustrating results of an ablation study with and without kernel and trajectory alignment, in accordance with an example embodiment;

FIG. 10G is a table illustrating inference time for different models at low and high resolution, in accordance with an example embodiment; and

FIG. 11 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

### Introduction

The advancements in large vision and language models have dramatically increased the capacity to process unstructured data, catalyzing a new era of multimodal and semantic generation. Inspired by this success, deep generative models (DGMs) have been leveraged in the scientific and engineering field, particularly for constraint-bound problems such as structural topology optimization, to expedite the design process.

Engineering designs predominantly rely on iterative optimization algorithms that discretize physical and chemical phenomena and iteratively improve design performance while meeting a set of constraint requirements. For instance, topology optimization aims to determine the optimal material distribution within a given design space, under specified loads and boundary conditions, to achieve the best performance according to a set of defined criteria, such as minimum weight or maximum stiffness. While iterative topology optimization methods hold great benefits, they face significant challenges in practical applications, especially for large-scale problems, owing to their computational complexity.

Recent advancements have sought to address these challenges by venturing into learning-based approaches for topology optimization, specifically deep generative models. These models are often trained on a dataset of optimal solutions under different constraints, to expedite or replace the optimization process and foster greater diversity in structural topologies by leveraging extensive datasets of pre-existing designs. This capacity to generate diverse solutions, coupled with the ability to consider multiple design variables, constraints, and objectives, makes learning-based methods particularly appealing in engineering design scenarios.

However, purely data-driven approaches to generative design tend to underperform compared to optimization-based methods. These methods typically focus on metrics like reconstruction quality, which often insufficiently capture the degree to which the engineering specifications are satisfied. The lack of physical information in data-driven methods and the absence of mechanisms to include iterative optimization details during the inference stage limit their effectiveness. This deficiency can limit the quality of the solutions generated, especially for problems with complex constraints and performance requirements. One or more embodiments advantageously provide techniques that combine data-driven and physics-based approaches to better address engineering challenges. To this end, structured generative models have shown great promise in generative topology optimization by leveraging techniques.

### Limitations

Despite these recent advances, structured generative models for engineering designs have several outstanding limitations. For instance, these models often require additional supervised training data to learn guidance mechanisms that can improve performance and manufacturability. In the case of diffusion models, the forward models also have to run tens or hundreds of times to obtain a suitable topology. Additionally, to condition the models on physical information, expensive FEA (Finite Element Analysis) preprocessing is required at both training and inference time to compute stress and energy fields. As a result, the sampling process is slow, and the inference process is computationally expensive, making it challenging to generalize and scale these methods effectively. This partially invalidates the advantages of data-driven approaches in terms of fast sampling and inexpensive design candidate generation.

### Generative models

Generative models have had a profound impact on vision and language, paving the way for a new era of multimodal generative applications. While these successes have inspired researchers to explore using generative models in science and engineering to accelerate the design process and reduce the reliance on iterative optimization, challenges remain. Specifically, engineering optimization methods based on physics still outperform generative models when dealing with constrained environments where data is scarce and precision is paramount.

### Generative Adversarial Networks

GANs, or generative adversarial networks, are a type of deep learning model that are widely used for generating new data that is similar to existing datasets. GANs include two parts: a generator and a discriminator. The generator creates new data, while the discriminator evaluates the authenticity of the generated data compared to the original dataset. The two components are trained together in an adversarial manner, with the generator attempting to produce data that can fool the discriminator, while the discriminator becomes more skilled at detecting fake data.

GANs are prone to mode collapse, a phenomenon where the generator produces a limited range of output that is not representative of the full range of the training data. GANs are also prone to saturation, a phenomenon where the generator or discriminator becomes stuck in a state where its gradients become extremely small or zero, resulting in a slow or stalled learning process. In other words, the model reaches a point where it is no longer able to improve, even with additional training data.

### Guided Conditional Diffusion Models

A pertinent concept underlying diffusion models is to convert an initial noise image into a target image by iteratively reversing the diffusion process. By leveraging conditioning and guidance signals, these models can better adhere to contextual information, such as a reference image or conditioning vector, thereby influencing the direction of image generation. This allows for finer control over the appearance of generated images, aligning them with the desired target. However, it is worth noting that diffusion models may have limitations in terms of sampling speed, due to the need to sample multiple layers, which can impact their overall efficiency during the sampling process.

### Diffusion Optimization Models

Generally, hybrid approaches that combine data-driven generative models with iterative optimization techniques, referred to as diffusion optimization models (DOM) herein, are disclosed. Such approaches leverage the power of DGM and the precision of an optimization solver based on the physical underlying phenomena to improve generative designs under constraints. The disclosed approaches combine the strengths of generative models with optimization methods to overcome these challenges, such as ensuring constraint satisfaction, precision in engineering design, meeting the required performance metrics and adherence to specific constraints, such as manufacturability, compliance, and volume fraction, and enabling more accurate and reliable design generation for engineering applications.

One or more embodiments provide a diffusion optimization model (DOM) and trajectory alignment (TA), as well as a learning framework that demonstrates the efficacy of aligning the sampling trajectory of diffusion models with the optimization trajectory derived from traditional physics-based methods. This alignment ensures that the sampling process remains grounded in the underlying physical principles. The disclosed method allows for generating feasible and high-performance designs in as few as two steps without the need for expensive preprocessing, external surrogate models, or additional labeled data. The disclosed framework is applied to structural topology optimization, a fundamental problem in mechanical design, evaluating its performance on in and out-of-distribution configurations. Exemplary results demonstrate that trajectory alignment outperforms state-of-the-art deep generative models on in-distribution configurations and halves the inference computational cost. When coupled with a few steps of optimization, it also improves manufacturability for out-of-distribution conditions. By significantly improving performance and inference efficiency, DOM enables the generation of high-quality designs in just a few steps and guides them toward regions of high performance and manufacturability, paving the way for the widespread application of generative models in large-scale data-driven design.

### Conditional Diffusion Models

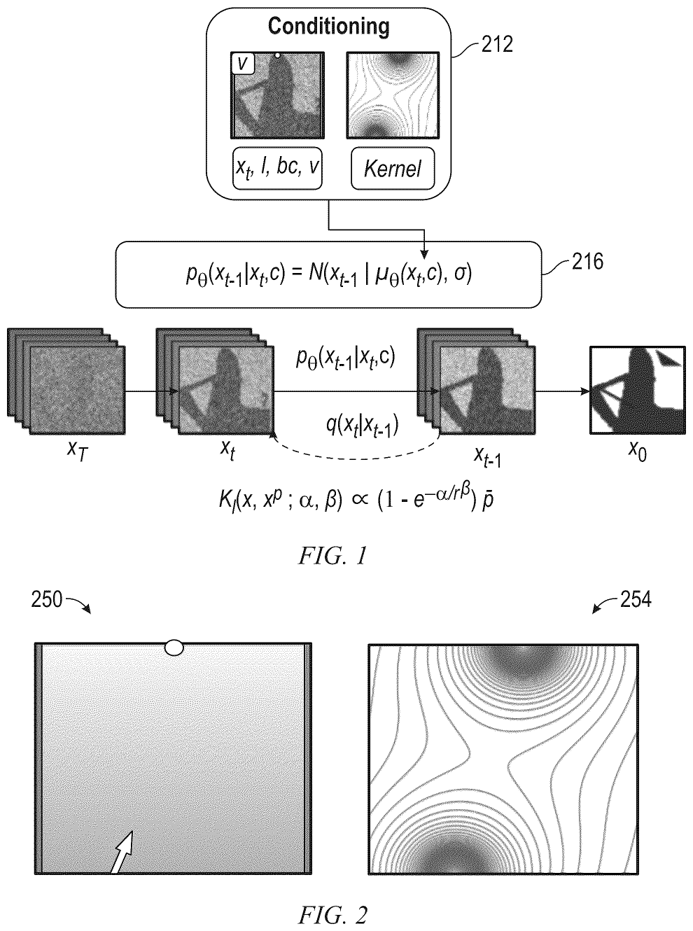

FIG. 1 illustrates a conditional diffusion model, in accordance with example embodiments. The model is conditioned 212 on constraints (loads, boundary conditions, volume fraction, and the like) and auxiliary information to generate designs that partially fulfill the requirements. Generative model 216 is the conditional diffusion model, described more fully below in the section entitled “DOM Solution.”

### Dense Relaxation

FIG. 2 illustrates a sparse conditioning field 250 (left-side) and a dense conditioning field 254 (right-side), both used for conditioning a diffusion model, in accordance with example embodiments. Notably, the dense relaxation is a computationally efficient approximation that can be achieved in a single step, without the need for domain knowledge or costly FEA solvers. This approach is highly scalable and adaptable to varying resolutions or domain structures, making it a cost-effective and versatile option for conditioning diffusion models.

Ex-Post Optimization

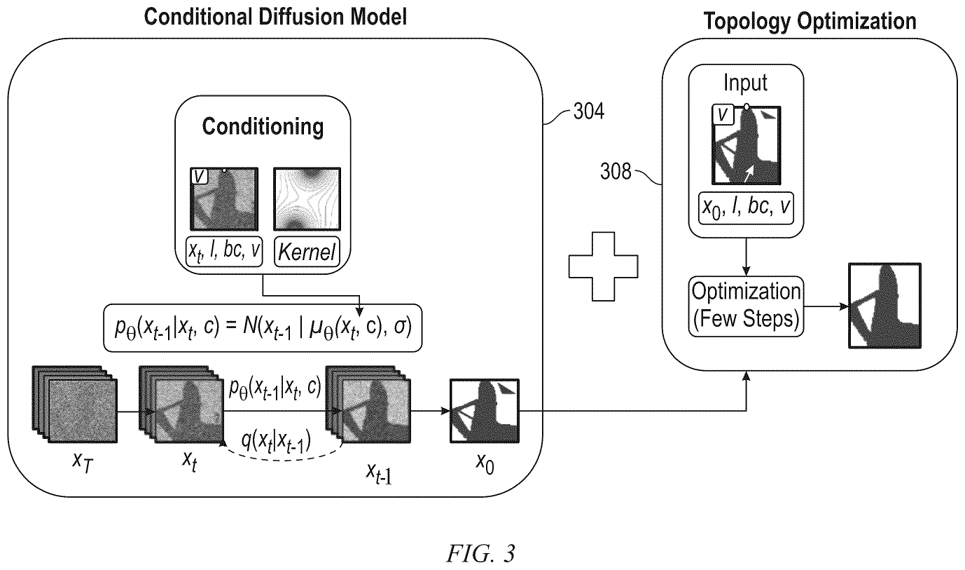

FIG. 3 illustrates a combined approach, which includes combining constrained diffusion model (CDM) 304 candidate generation with optimizer refinement 308, in accordance with example embodiments. After the generation step, the generated topology is further refined using a few iterations of Solid Isotropic Material Penalization (SIMP) (with, for example, a factor of 5 to 10) to eliminate floating material and reduce compliance. This iterative refinement step ensures that the generated designs not only adhere to the imposed constraints but also optimize the performance metrics of interest, resulting in improved and more feasible designs for engineering applications.

### DOM Solution

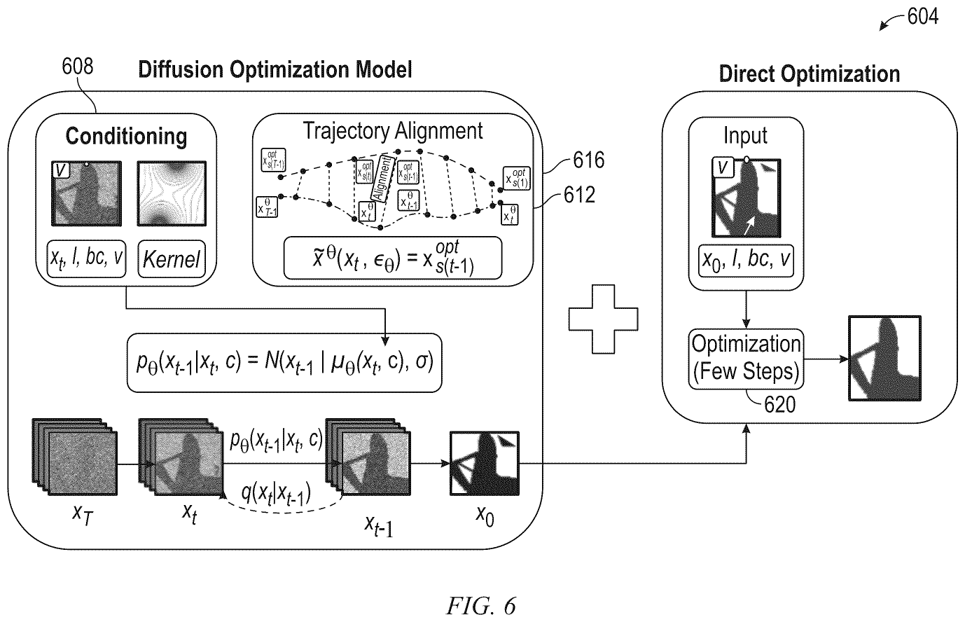

One or more embodiments provide a conditional diffusion optimization model 616 that integrates data-driven and optimization-based methods to learn constrained problems and generate candidates in the engineering design domains (see FIG. 6). Instead of relying on computationally heavy physics-based exact solutions using FEM, the exemplary method employs cost-effective physics-informed approximations to manage sparsity in conditioning constraints 608. A trajectory alignment (TA) mechanism 612 in the training phase is introduced that allows the model 616 to leverage the information in the physical trajectory that was used by the optimization-based solution in the training data, drastically cutting down the sampling steps required for a topology. This exemplary framework allows for further enhancing performance and manufacturability in complex situations by integrating a few stages of direct optimization. One or more embodiments significantly reduce computational costs without sacrificing accuracy or effectiveness and can easily be adapted to novel design problems. By bridging the gap between generative modeling and engineering design, an exemplary framework provides an efficient and effective solution for solving complex engineering problems. We have found that diffusion models benefit greatly in precision metrics by learning from the trajectory taken by optimization methods represented by intermediate solutions and not just their final outcome.

One or more embodiments employ a diffusion optimization model (DOM) 616, a versatile and efficient approach to incorporate performance awareness in generative models of engineering design problems while respecting constraints. A pertinent aspect of DOM 616 is to generate high-quality candidates rapidly and inexpensively, with a focus on topology optimization (TO) problems. In one or more embodiments, DOM 616 includes:

trajectory alignment (TA) 612 that leverages iterative optimization and hierarchical sampling to match paths, distilling the optimizer knowledge in the sampling process (DOM 616 achieves high performance without the need for FEM solvers or guidance and can sample high-quality configurations in as few as two steps) (reference herein to “DOM” should be understood to be references to one or more exemplary embodiments thereof, and it is not intended to imply that apparatuses or methods defined by the claims necessarily include elements discussed in the specification with reference to “DOM” but not specifically recited in the claims);

dense kernel relaxation 608, an efficient mechanism to relieve inference from expensive FEM pre-processing; and

few-steps direct optimization 620 that improves manufacturability using a few optimization steps.

Extensive quantitative and qualitative evaluations in-and out-of-distribution are performed, showing how kernel relaxation 608 and trajectory alignment 612 are both appropriate for good performance and fast, inexpensive sampling. A large, multi-fidelity dataset of sub-optimal and optimal topologies obtained by solving minimum compliance optimization problems was also generated. This dataset contains low-resolution (64×64), high-resolution (256×256), optimal (120k), and suboptimal (600K) topologies.

### DOM Introduction

The topology optimization problem, diffusion models, a class of deep generative models, conditioning and guidance mechanisms for diffusion models, and deep generative models for topology optimization are introduced below.

### The Topology Optimization Problem

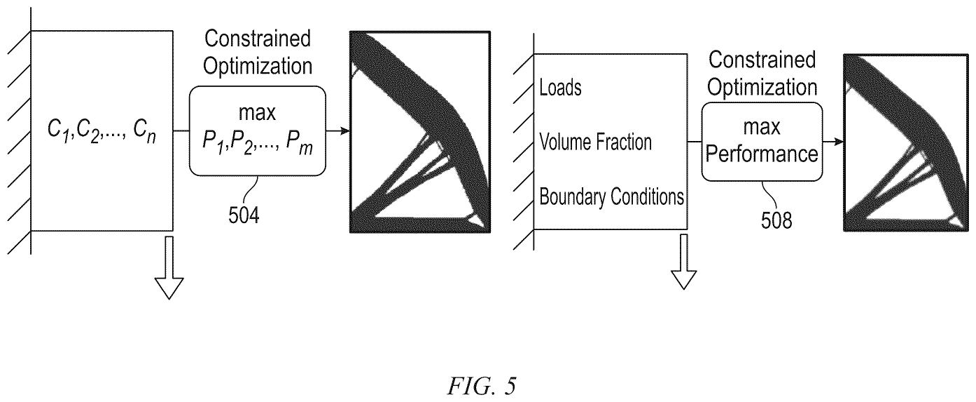

FIG. 5 a high-level view of topology optimization where the objective is to find the design with the minimum compliance under given loads, boundary conditions (BC), and volume fractions (VF), in accordance with example embodiments. Topology optimization is a computational design approach that aims to determine the optimal arrangement of a structure, taking into account a set of constraints. Its objective is to identify the most efficient utilization of material while ensuring the structure meets specific performance requirements. One widely used method in topology optimization is the Solid Isotropic Material with Penalization (SIMP) method. The SIMP method employs a density field to model the material properties, where the density indicates the proportion of material present in a particular region. The optimization process involves iteratively adjusting the density field, considering constraints such as stress or deformation. In the context of a mechanical system, a common objective is to solve a generic minimum compliance problem. This problem aims to find the distribution of material density, represented as x∈ [symbol] , that minimizes the deformation of the structure under prescribed boundary conditions and loads. Given a set of design variables x={xᵢ}ᵢ₌₀ⁿ, where n is the domain dimensionality, the minimum compliance problems can be written as:

$${min}_{x} c ( x ) = {F}^{T} U ( x ) \qquad ( 1 )$$

$$s . t . v ( x ) = {v}^{T} \times < \overline{v}$$

$$0 \leq x \leq 1$$

A pertinent goal in one or more embodiments is to find the design variables that minimize compliance c(x) given the constraints. F is the tensor of applied loads and U(x) is the node displacement, solution of the equilibrium equation K(x)U(x)=F where K(x) is the stiffness matrix and is a function of the considered material. v(x) is the required volume fraction. The problem is a relaxation of the topology optimization task, where the design variables are continuous between 0 and 1. One significant advantage of topology optimization is its ability to create optimized structures that meet specific performance requirements. However, a major drawback of topology optimization is that it can be computationally intensive and may require significant computational resources. Additionally, some approaches to topology optimization may be limited in their ability to generate highly complex geometries and/or may get stuck in local minima.

### Diffusion Models

Let xo denote the observed data x₀ ∈ [symbol] . Let x₀, . . . , x_{T} denote T latent variables in [symbol] . The forward or diffusion process q, the reverse or generative process p_{θ}, and the objective L are now introduced. The forward or diffusion process q is defined as: q(x_{1:T}|x₀)=q(x₁|x₀)Πₜ₌₂^{T}q(xₜ|xₜ₋₁). The beta schedule β₁, β₂, . . . , β_{T} is chosen such that the final latent image x_{T} is nearly Gaussian noise. The generative or inverse process p_{θ} is defined as: p_{θ}(xₒ, x_{1:T})=p_{θ}(x₀|x₁)p(x_{T})Πₜ₌₂^{T}p_{θ}(xₜ₋₁|xₜ). The neural network μ_{θ}(xₜ, t) is shared among all time steps and is conditioned on t. The model is trained with a re-weighted version of the evidence lower bound (ELBO) that relates to denoising score matching. The negative ELBO L can be written as:

$${q}_{} [ - log \frac{{p}_{θ} ( {x}_{0} , {x}_{1 : T} )}{q ( {x}_{1 : T} \vert {x}_{0} )} ] = {L}_{0} + {\sum }_{t = 2}^{T} {L}_{t - 1} + {L}_{T} , \qquad ( 2 )$$

where L₀= [symbol] _{q(x}_{₁}_{|x}_{₀}₎[−log p(x₀|x₁)] is the likelihood term (parameterized by a discretized Gaussian distribution) and, if β₁, . . . , B_{T} are fixed, L_{T}= [symbol] [q(x_{T}+|x₀), p(x_{T})] is a constant. The terms Lₜ₋₁ for t=2, . . . , T can be written as: Lₜ₋₁= [symbol] _{q(x}_{ₜ}_{|x}_{₀}₎ [symbol] [q(xₜ₋₁|xₜ, x₀)|p(xₜ₋₁|xₜ)]]. The terms L_{1:T-1} can be rewritten as a prediction of the noise ϵ added to x in q(xₜ|x₀). Parameterizing μ_{θ} using the noise prediction ϵ_{θ}, it can be written:

$${L}_{t - 1 , ϵ} ( x ) = {q ( ϵ )}_{} [ {w}_{t} {‖ {ϵ}_{θ} ( {x}_{t} ( {x}_{0} , ε ) ) - ϵ ‖}_{2}^{2} ] \qquad ( 3 )$$

where αₜ is a hyperparameter internal to the diffusion model that is selected a priori by the skilled artisan using heuristics and

$${w}_{t} = \frac{{β}_{t}^{2}}{2 {σ}_{t}^{2} {α}_{t} ( 1 - {\overline{α}}_{t} )} ,$$

which corresponds to the ELBO objective.

### Conditioning and Guidance

Conditional diffusion models have been adapted for constrained engineering problems with performance requirements. One conventional approach proposes to condition on loads, volume fraction, and physical fields to learn a constrained generative model. In particular, the generative model can be written as:

$${p}_{θ} ( {x}_{t - 1} \vert {x}_{t} , c , g ) = ( ( {x}_{t} ; {μ}_{θ} ( {x}_{t} , c ) ) + {\sum }_{p = 1}^{P} {g}_{p} , γ ) \qquad ( 4 )$$

where c is a conditioning term and is a function of the loads l, volume fraction ν, γ represents an inverse of the variance of the normal distribution and fields ƒ, i.e c=h(l, ν, f). The fields considered are the Von Mises stress σᵥₘ=\sqrt{σ₁₁²−σ₁₁σ₂₂+σ₂₂²+3σ₁₂²} and the strain energy density field W=(σ₁₁ϵ₂₂+σ₁₁ϵ₂₂+2σ₁₂ϵ₁₂)/2. Here, σᵢⱼ and ϵᵢⱼ are the stress and energy components over the domain. The term g is a guidance term, containing information to guide the sampling process toward regions with low floating material (using a classifier and g_{ƒm}) and regions with low compliance error, where the generated topologies are close to optimized one (using a regression model and g_{c}). Where conditioning c is always present and applied during training, the guidance mechanism g is optional and applied only at inference time.

### Limitations of Conventional Generative Models for Topology

One conventional generative model for topology is effective at generating topologies that fulfill the constraints and have low compliance errors. However, the generative model is expensive in terms of sampling time, because tens or hundreds of layers need to be sampled for each sample. Additionally, given the model conditions on the Von Mises stress and the strain energy density, for each configuration of loads and boundary conditions, the given configurations have to be preprocessed by running a FEM solver. In addition to being computationally expensive and time-consuming, this approach relies on fine-grained knowledge of the problem at hand in terms of material properties, domain, and input to the solver and performance metrics, limiting the applicability of such modeling techniques for different constrained problems in engineering or even more challenging topology problems. The guidance requires the training of two additional models (a classification and a regression model) and is particularly useful with out-of-distribution configurations. However, such guidance requires additional topologies, optimal and suboptimal, to train the regression model, assuming that there is access to the desired performance metric on the training set (similarly for the classifier, where additional labeled data typically has to be gathered).

### DOM Method

FIG. 6 is a block diagram of a DOM pipeline 604 with conditioning and kernel relaxation 608 (top left) and trajectory alignment 612 (top right), in accordance with an example embodiment. The diffusion optimization model 616 generates design candidates, which are further refined using optimization tools. After the generation step (left side), the generated topology is improved using a few steps of SIMP (5/10) (optimization 620) to remove floating material and improve performance (right side).

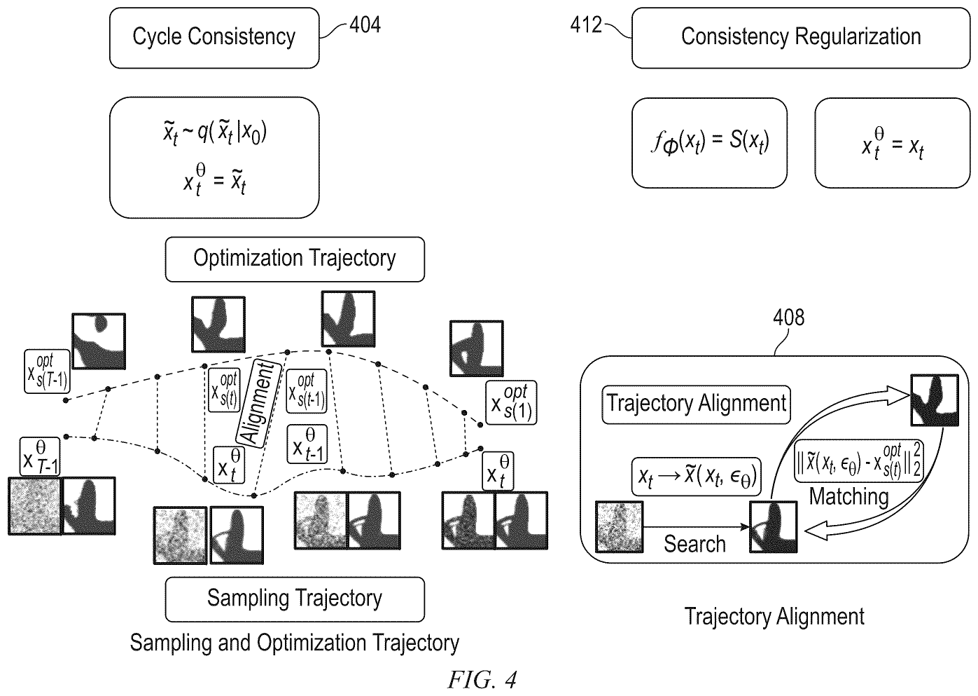

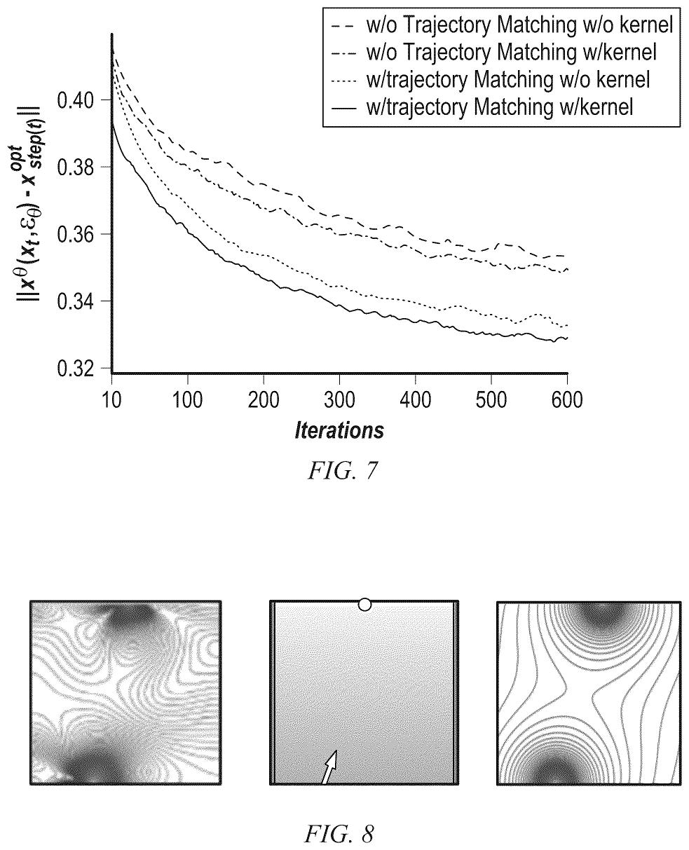

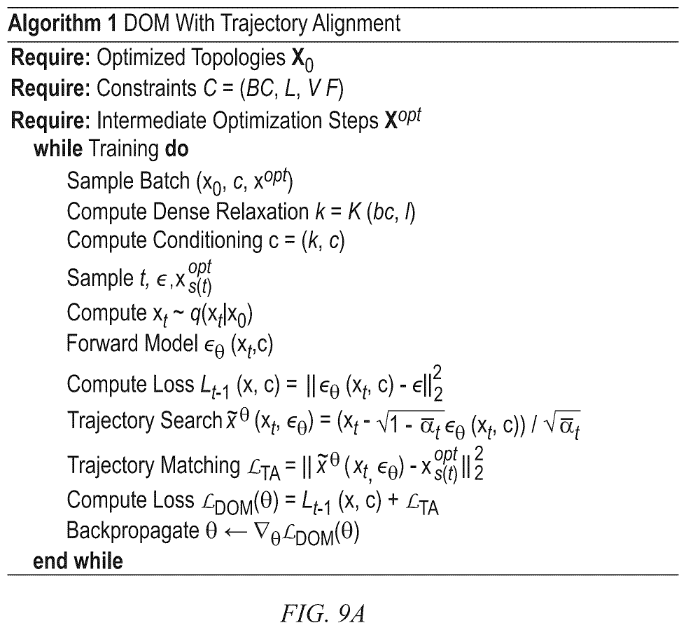

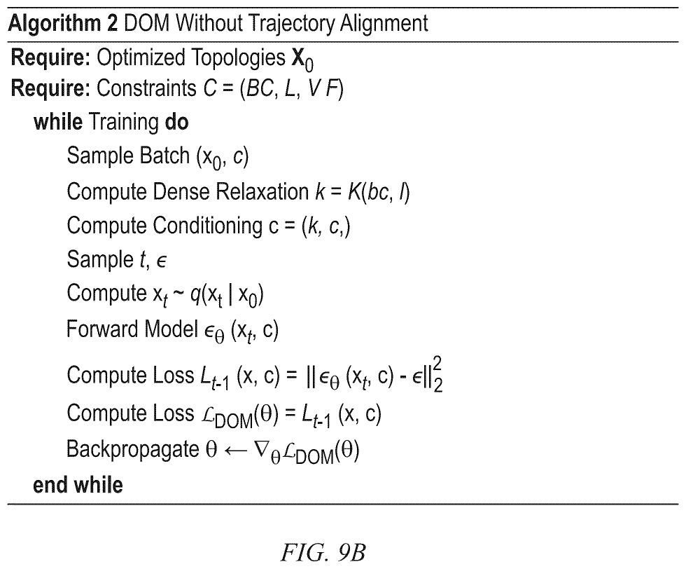

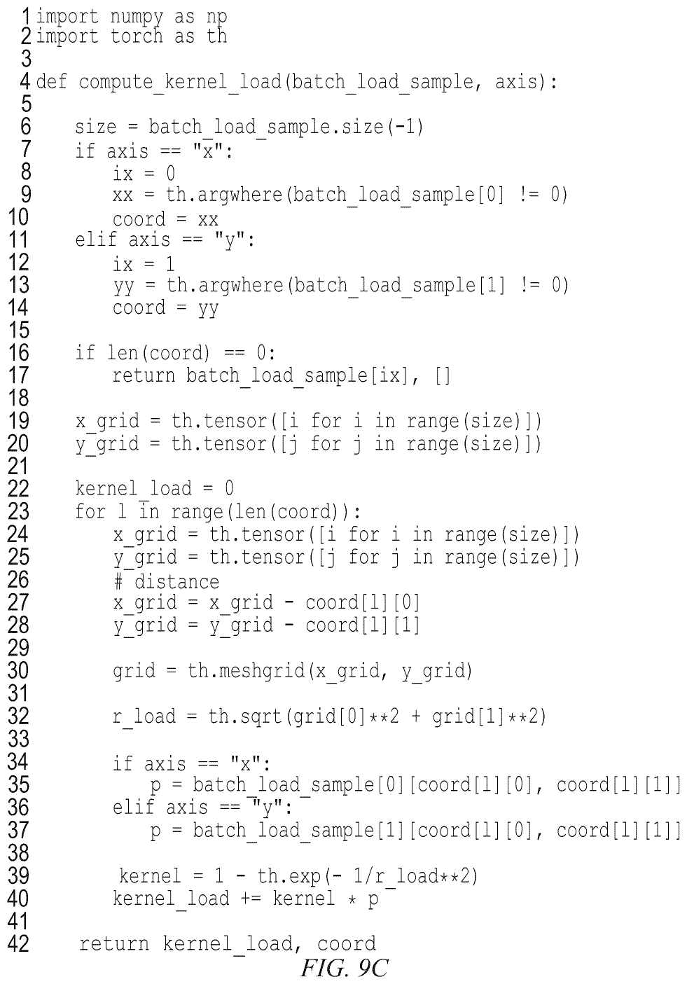

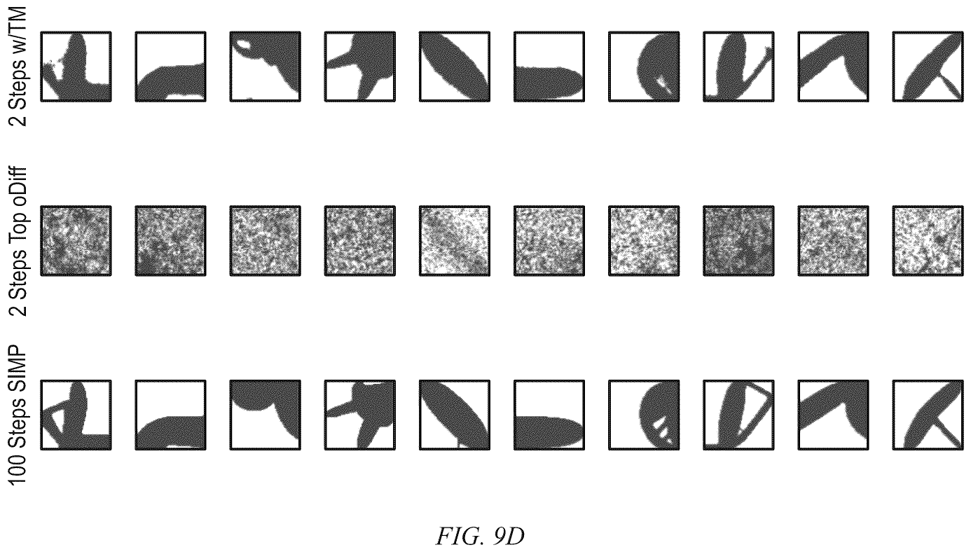

To tackle the limitations described above, one or more embodiments provide a diffusion optimization model (DOM) 616, a conditional diffusion model with the goal of improving constrained design generation. One pertinent goal is to improve inference time without loss in performance and constraint satisfaction. DOM 616 is based on three main components: (i) trajectory alignment 612 (see FIGS. 4 and 7) to ground sampling trajectory in the underlying physical process; (ii) dense kernel relaxation 608 (see FIG. 8) to make preprocessing efficient; and (iii) few-steps direct optimization 620 to improve out-of-distribution performance (see FIG. 6 for an overview). (See FIGS. 9A and 9B for algorithms with and without trajectory alignment.)

### Consistency Regularization—Cycle Consistency

FIG. 4 illustrates trajectory alignment 408 with cycle consistency 404 and consistency regularization 412, in accordance with an example embodiment. Intermediate sampling steps in a diffusion optimization model 616 are matched with intermediate optimization steps. In doing so, the sampling path is biased toward the optimization path, guiding the data-driven path toward physical trajectories. This leads to significantly more precise samples. As illustrated in FIG. 4, the biasing of the sampling path toward the optimization path is accomplished with cycle consistency 404 and consistency regularization 412. With consistency regularization 412, the disclosed diffusion optimization model 616 incorporates a mechanism that matches intermediate sampling steps with intermediate optimization steps, ensuring close alignment between the generated configurations and the optimized configurations. This mechanism enhances the consistency and fidelity of the generated designs with respect to the desired constraints and performance metrics, as the generated configurations follow the same optimization path as the optimized configurations. By incorporating the cycle consistency mechanism 404, one or more embodiments strengthen the alignment between the generative model and the optimization process, resulting in more reliable and accurate generated designs for engineering applications.

### Trajectory Alignment (TA)

One pertinent goal of one or more embodiments is to align the sampling trajectory with the optimization trajectory, incorporating optimization in data-driven generative models by leveraging the hierarchical sampling structure of diffusion models. This aligns trajectories with physics-based information, as illustrated in FIG. 4. Unlike previous approaches, which use optimization as pre-processing or post-processing steps, trajectory alignment 612 is performed during training and relies upon the marginalization property of diffusion models, i.e., q(xₜ|x₀)=∫q(x_{1:t}|x₀) Rdx_{1:t-1}, where xₜ=\sqrt{α̅ₜ}x₀+(1−α̅ₜ)ϵ, with ϵ˜N(0, 1). The trajectory alignment process 612 can match in clean space (matching step 0), noisy space (matching step t), performance space, and leverage multi-fidelity mechanisms. At a high-level, TA 612 is a regularization mechanism that injects an optimization-informed prior at each sampling step, forcing it to be close to the corresponding optimization step in terms of distance. This process provides a consistency mechanism over trajectories and significantly reduces the computational cost of generating candidates without sacrificing accuracy.

### Alignment Challenges

The alignment of sampling and optimization trajectories is challenging due to their differing lengths and structures. For example, the optimization trajectory starts with an image of all zeros, while the sampling path starts with random noise. Furthermore, diffusion models define a Stochastic Differential Equation (SDE) in the continuous limit, which represents a collection of trajectories, and the optimization trajectory cannot be directly represented within this set. To address these issues, in one or more embodiments, trajectory alignment 612 includes two phases (see FIG. 4): a search phase and a matching phase. In the search phase, the aim is to find the closest trajectory, among those that can be represented by the reverse process, to the optimization trajectory. This involves identifying a suitable representation over a trajectory that aligns with the optimization process.

### Trajectory Search

The approximate posterior and marginalization properties of diffusion models are leveraged to perform a trajectory search, using the generative model as a parametric guide to search for a suitable representation for alignment. Given an initial point x₀, an approximate point xₜ is obtained by sampling from the posterior distribution q(xₜ|x₀). ϵ_{θ}(xₜ) is then predicted with the model and used to obtain \tilde{x}^{θ}(xₜ, ϵ_{θ}(xₜ)). In Denoising Diffusion Probabilistic Models (DDPM), \tilde{x}^{θ} is an approximation of x₀ and is used as an intermediate step to sample xₜ₋₁^{θ} using the posterior functional form q(xₜ₋₁^{θ}|xₜ, \tilde{x}^{θ}). In DOM 616, \tilde{x}^{θ} is additionally leveraged to transport the sampling step towards a suitable representation for matching an intermediate optimization step xₛₜₑₚ₍ₜ₎^{opt} corresponding to t using some mapping. Trajectory alignment 612 involves matching the optimization trajectory, which is an iterative exact solution for physics-based problems, with the sampling trajectory, which is the hierarchical sampling mechanism leveraged in diffusion models and hierarchical variational autoencoders (VAEs). In practice, in DOM 616, xₜ=\sqrt{α̅ₜ} x₀+(1−α̅ ₜ)ϵ is sampled from q(xₜ|x₀) and a forward step is run with the inverse process ϵ_{θ}(xₜ|x₀) conditioning on the constraints c to obtain the matching representation \tilde{x}^{θ} for step t:

$${\tilde{x}}^{θ} ∼ q ( {\tilde{x}}^{θ} \vert {\tilde{μ}}^{θ} ( {x}_{t} , {ϵ}_{θ} ) , γ ) \qquad ( 5 )$$

$${\tilde{μ}}^{θ} ( {x}_{t} , {ϵ}_{θ} ) = ( {x}_{t} - \sqrt{1 - {\overline{α}}_{t}} {ϵ}_{θ} ( {x}_{t} , c ) ) / \sqrt{{\overline{α}}_{t}}$$

### Trajectory Matching

After the trajectory search, the distribution of matching representation q(\tilde{x}^{θ}|xₜ, ϵ_{θ}) for sampling step t is matched with the distribution of optimized representations q(xₛ₍ₜ₋₁₎^{opt}|opt) at iteration s (corresponding to step t−1) conditioning on the optimizer S. In general, given that the sampling steps will be different than the optimization steps, s(t−1)=mod((t−1),nₛ) is used where nₛ is the number of optimized iterations stored. The model can then be trained as a weighted sum of the conditional DDPM objective and the trajectory alignment regularization:

$${ℒ}_{D O M} = {}_{q ( {x}_{t} \vert {x}_{0} )} [ \text{} [ q ( {x}_{t - 1} \vert {x}_{t} , {x}_{0} ) \vert {p}_{θ} ( {x}_{t - 1}^{θ} \vert {x}_{t} , c ) ] + [ q ( {\tilde{x}}^{θ} \vert {x}_{t} , {ϵ}_{0} ) \vert q ( {x}_{s ( t - 1 )} \vert opt ) ] \qquad ( 6 )$$

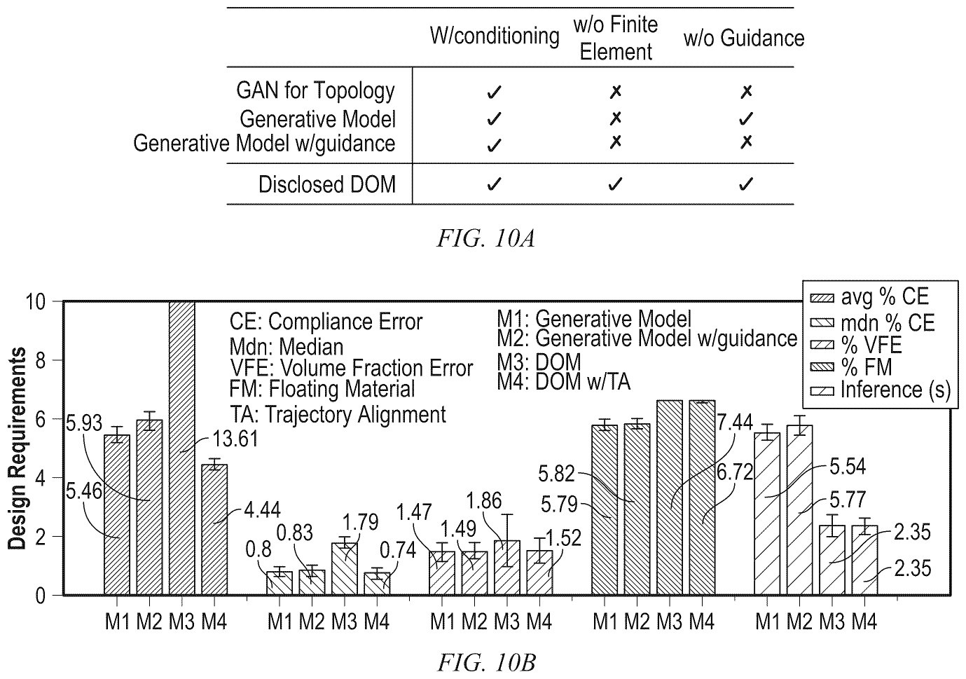

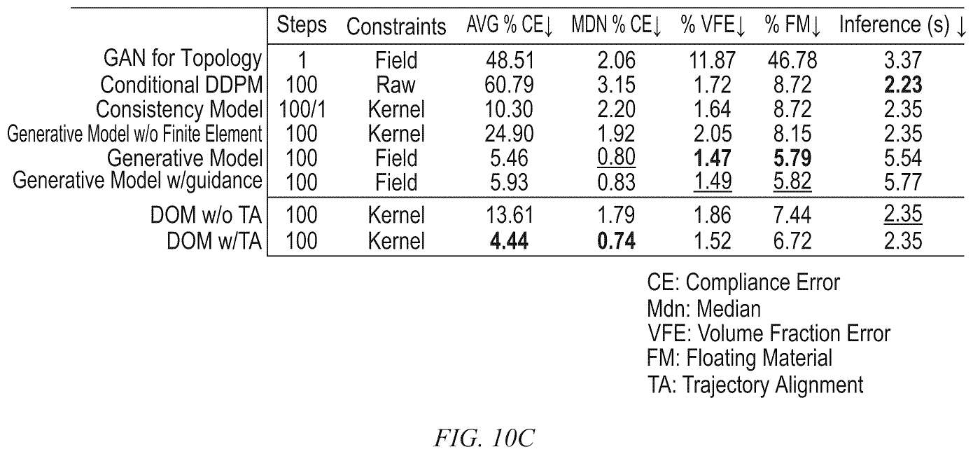

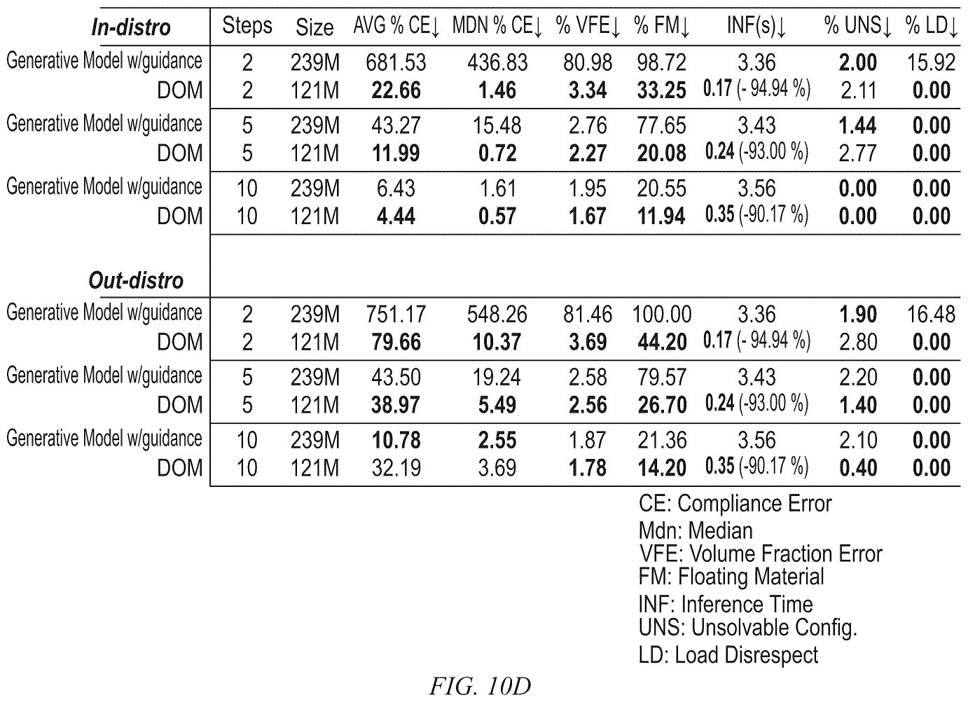

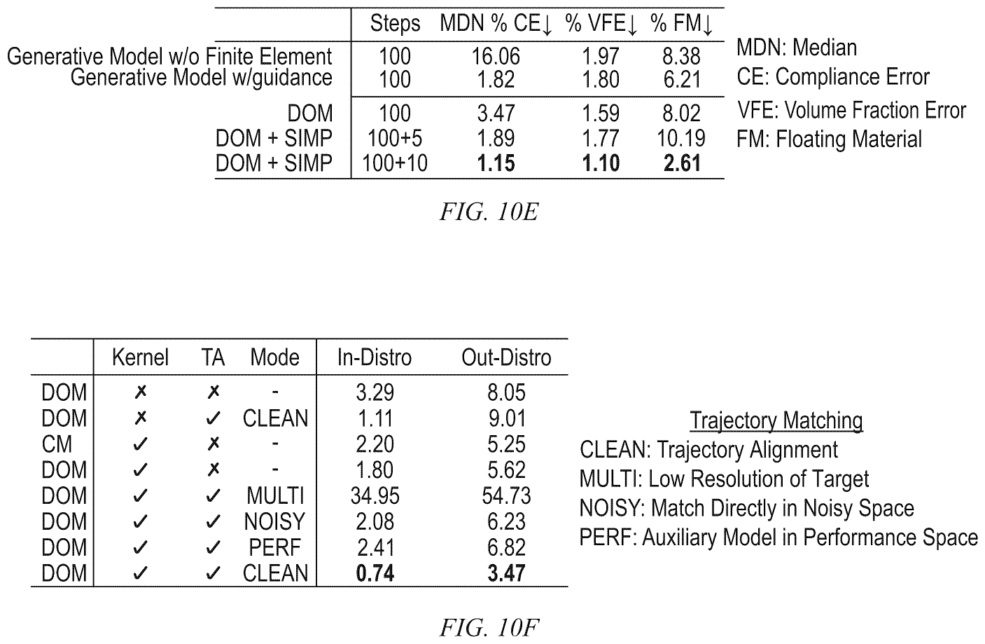

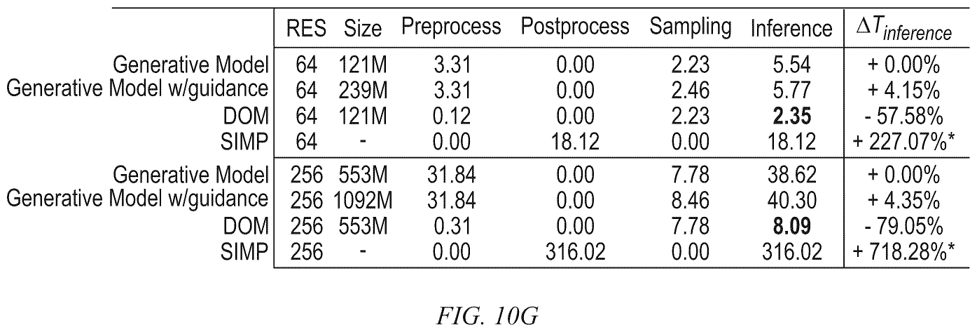

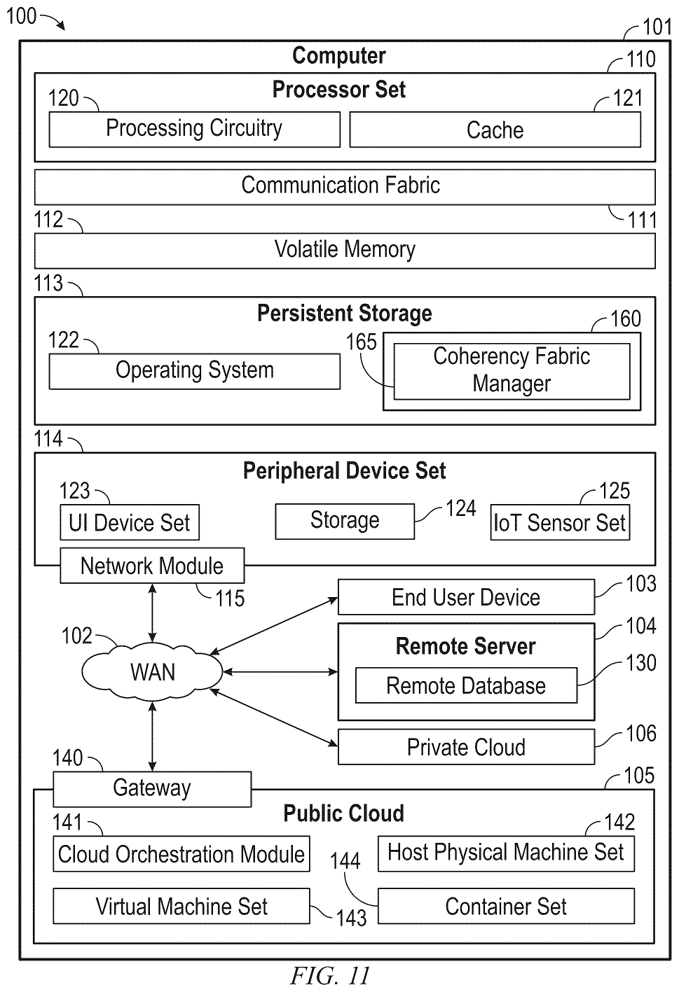

This mechanism effectively pushes the sampling trajectory at each step to match the optimization trajectory, distilling the optimizer during the reverse process training. In practice, following practice in DDPM literature, the distribution variances are not learned from data. For the trajectory alignment distributions, the dispersion is set to the same values used in the model. By doing so, the per-step negated lower-bound can be rewritten as a weighted sum of squared errors:

$${ℒ}_{DOM} = {}_{q ( ε )} [ {w}_{t} {‖ {ϵ}_{θ} ( {x}_{t} ( {x}_{0} , ϵ ) , c ) - ϵ ‖}_{2}^{2} ] + {α}_{c} {‖ {\tilde{x}}^{θ} ( {x}_{t} , {ϵ}_{θ} ) - {x}_{s ( t - 1 )}^{opt} ‖}_{2}^{2} \qquad ( 7 )$$

where [symbol] is the trajectory alignment loss for step t, and L_{t-1,ε}(x, c) is a conditional DDPM loss for step t. This is the formulation employed for a model according to one or more embodiments, where this loss is optimized for the mean values, the mean representations are frozen, and the variances are optimized in a separate step. Alignment can also be performed in alternative ways. Matching in noisy spaces can be performed, using the marginal posterior to obtain a noisy optimized representation for step t−1, q(xₜ₋₁^{opt}|xₛ₍₀₎^{opt}) and then optimize [symbol] =αₙ∥xₜ₋₁^{θ}−xₜ₋₁^{opt}∥₂². Finally, matching in performance space can be performed: this approach leverages an auxiliary model ƒ_{ϕ} similar to consistency models and performs trajectory alignment 612 in functional space, [symbol] =αₚ∥ƒ_{ϕ}(xₜ₋₁^{θ})−Pₛ₍ₜ₋₁₎∥₂, where the performance for the generated intermediate design is matched with the ground truth intermediate performance Pₛ₍ₜ₋₁₎ for the optimized xₛ₍ₜ₋₁₎^{opt}. These and other variants are compared in the table of FIG. 10F.

### Dense Conditioning over Sparse Constraints

FIG. 8 shows a comparison of iterative (left), sparse (center), and dense single-step (right) conditioning fields for a constrained diffusion model, in accordance with an example embodiment. Unlike the expensive iterative FEA method, the physics-inspired fields offer a cost-effective, single-step approximation that is domain-agnostic and scalable. In the matching phase, the distance between points on the sampling and optimization trajectories are minimized to ensure proximity between points and alignment between trajectories is enabled.

Models are subject to conditioning based on loads, boundary conditions, and volume fractions. In addition, the conventional generative models for topology and the conventional generative models for topology with guidance undergo conditioning based on force field and energy strain, while the conventional generative models for topology without the use of finite elements and without the use of guidance and DOM are conditioned based on a dense kernel relaxation, which defines integral functions that are solutions to the time-invariant Poisson's Equation. A pertinent aspect is to use the kernels as approximations to represent the effects of the boundary conditions and loads as smooth functions across the domain (see FIG. 8). This approach avoids the need for computationally expensive and time-consuming Finite Element Analysis (FEA) to provide conditioning information. For a load or source l, a sink or boundary b and r=

$${‖ x - {x}_{l} ‖}_{2} = \sqrt{{( {x}_{i} - {x}_{i}^{l} )}^{2} + {( {x}_{j} - {x}_{j}^{l} )}^{2}} , then : \qquad ( 8 )$$

$${K}_{l} ( x , {x}_{l} ; α ) = {\sum }_{l = 1}^{L} ( 1 - {e}^{- α / {‖ x - {x}_{l} ‖}_{2}^{2}} ) \overline{p} ( {x}_{l} )$$

$${K}_{b} ( x , {x}_{b} ; α ) = {\sum }_{b = 1}^{B} {e}^{- α / {‖ x - {x}_{b} ‖}_{2}^{2}} / {max}_{x} ( {\sum }_{b = 1}^{B} {e}^{- α / {‖ x - {x}_{b} ‖}_{2}^{2}} )$$

where p̅ is the module of a generic force in 2D. Notice how, for r→0, Kₗ(x, xₗ)→p, and r→∞, Kₗ(x, x₁)→0. It is noticed how closer to the boundary the kernel is null, and farther from the boundary the kernel tends to 1. Note that the choice of α parameters in the kernels affects the smoothness and range of the kernel functions. Furthermore, these kernels are isotropic, meaning that they do not depend on the direction in which they are applied. Overall, the kernel relaxation method offers a computationally inexpensive way to condition generative models on boundary conditions and loads, making them more applicable in practical engineering and design contexts.

### Few-Steps Direct Optimization

Finally, direct optimization is leveraged in one or more embodiments to improve the data-driven candidate generated by DOM 616. In particular, by running a few steps of optimization (5/10), physics information can be injected into the generated design directly, greatly increasing not only performance but greatly increasing manufacturability. Given a sample from the model \tilde{x}^{θ}˜p_{θ}(x₀|x₁)p_{θ}(x_{1:T}), it can be post-processed to obtain x₀=opt(\tilde{x}₀^{θ}, n), an improved design leveraging n steps of optimization, where n ∈ [5, 10].

### Algorithms

FIG. 9A illustrates a first example training algorithm for DOM 616 with trajectory alignment 612, in accordance with example embodiments. In one example embodiment, optimized topologies X₀, constraints C (including loads, boundary conditions (BC), and volume fractions (VF)), and intermediate optimization steps X^{opt} are obtained. A sample batch (x₀, c, x^{opt}) is accessed and a dense relaxation is computed (k=K (bc,l)). The conditioning (c=(k, c)) is computed and a sample (t, ϵ, xₛ₍ₜ₎^{opt}) is selected from the sample batch that corresponds to a randomly selected value of t from a given range of iterations, where ϵ is an amount of noise randomly selected from a Gaussian distribution (such as a bell shaped curve centered at zero with a variance of one). For each element, a distribution q(xₜ|x₀) is built using a random walk technique based on the value of t used for sampling the corresponding element from the sample batch and based on the corresponding randomly selected amount of noise ϵ (modulated by the value of t). A sample at iteration t is generated based on xₜ˜q(xₜ|x₀) and the forward model is run to make a prediction (ϵ_{θ}=ϵ_{θ}(xₜ, c)). The loss Lt−1 is computed to minimize the error between the prediction and the target (where the target is the noise ϵ that was sampled), the trajectory search is conducted and the trajectory matching is performed (to move the sampling path as close as possible to the optimization path). The loss [symbol] _{DOM} is computed and the model is updated using backpropagation.

FIG. 9B illustrates a second example algorithm for DOM 616 without trajectory alignment 612, in accordance with example embodiments. The algorithm of FIG. 9B is similar to the algorithm of FIG. 9A, with the exclusion of the trajectory search and the trajectory matching. FIG. 9C illustrates an example code listing for dense kernel relaxation 608 for sparse loads, in accordance with example embodiments.

### Experiments

FIG. 9D illustrates a few-step sampling for topology generation, in accordance with example embodiments. (Top row: diffusion optimization model (DOM) with trajectory alignment; middle row: the conventional generative model for topology with guidance; and bottom row: the optimization result.) DOM produces high-quality designs in as few as two steps, greatly enhancing inference efficiency compared to previous models requiring 10-100 steps. Trajectory alignment helps DOM generate near-optimal geometries swiftly, improving few-step sampling in conditional diffusion models for topology optimization.

Pertinent objectives of one or more exemplary embodiments include: (1) improving inference efficiency, and reducing the sampling time for diffusion-based topology generation while still satisfying the design requirements with a minimum decrease in performance; (2) minimizing reliance on force and strain fields as conditioning information, reducing the computation burden at inference time and the need for ad-hoc conditioning mechanisms for each problem; and (3) merging together learning-based and optimization-based methods, refining the topology generated using a conditional diffusion model, and improving the final solution in terms of manufacturability and performance.

### Setup

All the models for the non-limiting examples discussed herein were trained for 200,000 steps on 30,000 optimized topologies on a 64×64 domain. For each optimized topology, there was access to a small subset (5 steps) of intermediate optimization steps. The hyperparameters, conditioning structure, and training routine were set based on conventional settings. For all the models, conditioning was on volume fraction and loads. For the conventional generative model for topology, conditioning was on additional stress and energy fields. For a variant of the conventional generative model for topology conditioning on a kernel relaxation (without the use of finite elements and without the use of guidance), conditioning was on boundary conditions and kernels. The conventional generative model for topology with guidance leverages a compliance regressor and floating material classifier guidance. A reduced number of sampling steps were used for all the experiments.

### Dataset

A dataset of optimized topologies gathered using SIMP was used. Together with the topologies, the dataset includes information about optimal performance. For each topology, there is information about the loading condition, boundary condition, volume fraction, and optimal compliance. Additionally, for each constraint configuration, a pre-processing step computes the force and strain energy fields (see FIG. 8) when needed.

### Evaluation

FIG. 10A is a table showing configurations of a comparative study of generative models in topology optimization considering factors like conditional input (COND), finite element method (FEM), and guidance (GUID), in accordance with an example embodiment. Unlike other models, the DOM model operates without FEM preprocessing or GUIDANCE.

The model was evaluated using engineering and generative metrics. In particular, metrics that evaluated how well the disclosed model fulfills the following were considered: physical constraints using error with respect to prescribed volume fraction (VFE); engineering constraints, as manufacturability as measured by floating material (FM); performance constraints, as measured by compliance error (CE) with respect to the optimized SIMP solution; and sampling time constraints (inference constraints) as measured by sampling time (inference and pre-processing). Two scenarios of increasing complexity were considered:
(i) in-distribution constraints. The constraints in this test set are the same as those of the training set. When measuring performance on this set, generated configurations were filtered with high compliance.
(ii) Out-of-distribution constraints. The constraints in this test set are different from those of the training set. When measuring performance on this set, generated configurations are filtered with high compliance.

The purpose of these tasks is to evaluate the generalization capability of the machine learning models in-and out-of-distribution. By testing the models on different test sets with varying levels of difficulty, how well the models can perform on new, unseen data can be assessed. More importantly, it is important to understand how important the role of the force field and energy strain is with unknown constraints.

### In-Distribution Constraints

FIG. 10B is a bar graph of confidence intervals for design requirements for in-distribution constraint configurations, in accordance with an example embodiment. FIG. 10C is a table illustrating results of an evaluation of different model variants on in-distribution constraints, in accordance with an example embodiment. (CE: compliance error; VFE: volume fraction error; and FM: floating material.) In the experiments of FIG. 10C, 100 sampling steps were used for all diffusion models. It can be seen that DOM w/TA is competitive with the state-of-the-art (SOTA) models on topology generation, being computationally 50% less expensive at inference time compared to the conventional generative model for topology. Trajectory alignment greatly improves performance without any additional inference cost. (See FIG. 10B for confidence intervals.)

The table of FIG. 10C reports the evaluation results in terms of constraints satisfaction and performance for the task of topology generation. These results demonstrate the advantage of an evaluation that considers the performance and feasibility of the generated design, in accordance with one or more embodiments.

In the table of FIG. 10C, DOM achieves high performance and is at least 50% less computationally expensive at inference time, not requiring FEM preprocessing or additional guidance through surrogate models like a conventional generative adversarial network (GAN) for topology optimization and the conventional generative model for topology. Exemplary embodiments were also compared with conventional consistency models, a diffusion model that tries to predict its input at each step. DOM can be seen as a generalization of such a method when a trajectory is available as a ground truth. Overall, DOM with trajectory alignment is competitive or better than the prior art techniques in terms of performance on in-distribution constraints, providing strong evidence that TA is an effective mechanism to guide the sampling path toward regions of high performance.

### Generation with Few-Steps of Sampling

FIG. 10D is a table illustrating results of evaluating sampling topologies with few steps (2-10) for the conventional generative model for topology and DOM (G: guided using regression and classifier guidance; AVG CE: average compliance error; MDN CE: median compliance error; VFE: volume fraction error; FM: floating material; INF: inference time; UNS: unsolvable configurations; and LD: load disrespect), in accordance with an example embodiment. DOM largely outperforms the conventional generative model for topology in the few sampling step regimes, showing trajectory alignment's effectiveness as a grounding mechanism. DOM can generate reasonable topologies in just two sampling steps, where the conventional generative model for topology and DOM without trajectory alignment fail, even presenting cases of load disrespect. The table of FIG. 10D compares two different algorithms, the conventional generative model for topology with guidance and DOM, in terms of their performance when using only a few steps for sampling. The table shows the results of the in and out-of-distribution comparison, with the conventional generative model for topology with guidance and DOM both having STEPS values of 2, 5, and 10, and SIZE of 239 million (M) and 121 M. It can be seen that DOM outperforms the conventional generative model for topology with guidance by a large margin when tasked with generating a new topology given a few steps, corroborating the disclosed hypothesis that aligning the sampling and optimization trajectory is an effective mechanism to obtain efficient generative models that satisfy constraints. DOM outperforms the conventional generative model for topology with guidance (even while being 50% smaller), without leveraging an expensive FEM solver for conditioning but relying on inexpensive dense relaxations, making it 10 to 20 times faster at sampling, and greatly enhancing the quality of the generated designs, providing evidence that trajectory alignment is an effective mechanism to distill information from the optimization path. In FIG. 9D, qualitative results are provided to show how DOM (top row) is able to generate reasonable topologies, resembling the fully optimized structure running SIMP for 100 steps (bottom row), with just two steps at inference time, where the same model without TA or the conventional generative model for topology are not able to perform such a task. Overall, these results corroborate the disclosed thesis regarding the usefulness of trajectory alignment for high-quality constrained generation.

### Merging Generative Models and Optimization for Out-of-Distribution Constraints

FIG. 10E is a table illustrating the results of an out-of-distribution scenario comparison, in accordance with an example embodiment. The conventional generative model for topology with guidance outperforms DOM due to its adaptive conditioning mechanism, which leverages expensive FEM computed fields. However, DOM coupled with a few steps of direct optimization (5 to 10 steps) greatly surpasses the conventional generative model for topology in performance and manufacturability. This underscores the effectiveness of integrating data-driven and optimization methods in constrained design creation.

As illustrated in the table of FIG. 10E, employing FEM and guidance significantly enhances the performance of the conventional generative model for topology. Conditioning on the FEM output during inference can be seen as a form of test-time conditioning that can be adapted to the sample at hand. However, merging DOM and a few iterations of optimization is extremely effective in solving this problem, in particular in terms of improving volume fraction and floating material. Using the combination of DOM and SIMP is a way to impose the performance constraints in the model without the need for surrogate models or guidance.

### Trajectory Alignment Ablation

A core contribution of DOM is trajectory alignment, a method to match sampling and optimization trajectories of arbitrary length and structure mapping intermediate steps to appropriate CLEAN (noise free or with reduced noise using the model and the marginalization properties of DDPM) representations. However, alignment can be performed in multiple ways, leveraging NOISY representation, matching performance (PERF), and using data at a higher resolution to impose consistency (MULTI). FIG. 10F is a table illustrating results of an ablation study with and without kernel and trajectory alignment, in accordance with an example embodiment. Different ways to match the sampling and optimization trajectory are explored and the median compliance error is measured. (TA: trajectory alignment; CM: consistency models.) In the table of FIG. 10F, an ablation study is performed, considering DOM with and without kernel relaxation, and leveraging different kinds of trajectory matching. From the table, it is seen that using dense conditioning is quite pertinent for out-of-distribution performance, and that matching using CLEAN is the most effective method in and out-of-distribution. FIG. 7 is a graphical report of a visualization of the distance between sampling and optimization trajectory during training, in accordance with an example embodiment. The visualization illustrates the distance between intermediate sampling steps in DOM and optimization steps with and without trajectory alignment. Given a random sampling step t and the corresponding optimization step s(t)=mod(t, n) where n ∈ [2, 10], the matching in clean space is computed, using the approximate posterior q to obtain an estimate for x^{θ} given xₜ and the noise prediction ϵ_{θ}. Then, the distance ∥\tilde{x}^{θ}(xₜ, ϵ_{θ})−xₛ₍ₜ₎^{opt}∥₂ is computed. From this plot, it can be seen how the kernel together with TA helps the model to find trajectories that are closer to the optimal one, again corroborating the need for dense conditioning and consistency regularization.

### Inference Time

With the previous experiments, it is proven that a data-driven approach, biased towards the physical process, can distill the optimization process and sample a novel topology in a few steps. Experiments are provided for in and out-of-distribution settings, and ablate the disclosed choice of kernel relaxation and trajectory alignment mechanism. However, the final goal of data-driven design is to learn a general tool for fast candidate generation. Here, inference time for different models is compared and, more importantly, for low- (64 pixels) and high-resolution (256 pixels). Given the computational burden of training such models at high resolution, all the models were trained for only 10,000 steps (around 5% of the full training), and then were used for sampling. With this experiment, it is emphasized how fast DOM can perform inference compared to a SOTA model. All the generative models were run and optimized for 100 steps: this setting is not suited for DOM, because, as was seen, the model excels in the few-step sampling task. FIG. 10G is a table illustrating inference time for different models at low and high resolution, in accordance with an example embodiment. For all the diffusion models, sampling was performed for 100 steps and, for SIMP, iterating was performed for 100 steps. Optimization time was reported for a full comparison, but it is pertinent to note that SIMP runs on a central processing unit (CPU) and the DDPM-based models on graphics processing unit (GPU). (ΔT_{inference}=(T_{model}−T_{topodiff})/T_{topodiff}.) The table of FIG. 10G presents a comparison of various models based on different factors, such as resolution (RES), size, preprocess time, postprocess time, sampling, and inference time.

### Experiments—Topology Optimization

By merging a data-driven approach, such as the diffusion optimization model (DOM), with a few steps of optimization, the performance of the generated designs can be significantly improved. The hybrid approach according to one or more embodiments results in lower compliance and compliance error compared to purely generative approaches, indicating improved optimization of the performance metrics of interest.

Moreover, the approach according to one or more embodiments also enhances constraint satisfaction (as reflected by lower volume fraction error (VFE)) and/or improves manufacturability by reducing floating material (FM) in the generated samples. This combined approach leverages the strengths of both data-driven and optimization techniques, resulting in more optimized and manufacturable designs that meet the desired constraints for engineering applications.

One or more embodiments provide structural topology optimization techniques for optimizing the use of material (e.g., finding optimal shape of a structural member) in a structure under a load with known constraints. A simple, non-limiting example, is the case of a cantilevered beam (i.e., one built-in end, one free end) with a load on the free end. Techniques in accordance with one or more embodiments could determine that the optimal shape was an I-beam having most of the material in the flanges and having a web just sufficiently thick to resist shear and buckling. Once a design has been developed, it can be simulated using finite element analysis and/or a prototype can be tested. If the simulations/tests yield acceptable results, the design can be released, fabricated, and deployed. If the simulations/tests yield unacceptable results, the design can be adjusted using aspects of machine learning as discussed herein and/or other manual or computer aided-techniques. A computer-controlled machine tool such as a computer numerical control (CNC) milling machine, three-dimensional printer or the like could be used to fabricate a prototype or production structural element. As will be appreciated by the skilled artisan, exemplary embodiments can be used with many different types of loads (e.g., point load, load per unit length, load per unit area, load per unit volume, static and dynamic loads, and the like) and many different constraints (e.g., cantilever/built in providing three force components and three moments; pinned providing force components but no moment; roller providing only a normal force component; and the like)-generally, any boundary condition or the like that reduces one or more degrees of freedom. In addition to a single structural element, a more complicated structure with multiple structural members, such as a bridge, could also be optimized.

Given the discussion thus far, it will be appreciated that, in general terms, an exemplary method, according to an aspect of the invention, includes the operations of accessing a sample batch; computing a conditioning based on given constraints; computing a dense relaxation based on the computed conditioning and the sample batch to generate kernels for conditioning a diffusion optimization model 616; selecting a sample from the sample batch based on a randomly sampled timestep and sampling random noise from a Gaussian distribution; sampling, based on the randomly sampled timestep, a noisy representation of the selected sample based on the sampled random noise; running the diffusion optimization model 616 in a forward direction using the noisy representation of the selected sample to generate a prediction; computing an error loss to minimize an error between the prediction and a target, where the target is the sampled random noise; computing a diffusion optimization loss based on the error loss; and updating the diffusion optimization model 616 based on the diffusion optimization loss using backpropagation.

In one aspect, a computer program product comprises one or more tangible computer-readable storage media and program instructions stored on at least one of the one or more tangible computer-readable storage media, the program instructions executable by a processor, the program instructions comprising accessing a sample batch; computing a conditioning based on given constraints; computing a dense relaxation based on the computed conditioning and the sample batch to generate kernels for conditioning a diffusion optimization model 616; selecting a sample from the sample batch based on a randomly sampled timestep and sampling random noise from a Gaussian distribution; sampling, based on the randomly sampled timestep, a noisy representation of the selected sample based on the sampled random noise; running the diffusion optimization model 616 in a forward direction using the noisy representation of the selected sample to generate a prediction; computing an error loss to minimize an error between the prediction and a target, where the target is the sampled random noise; computing a diffusion optimization loss based on the error loss; and updating the diffusion optimization model 616 based on the diffusion optimization loss using backpropagation.

In one aspect, a system comprises a memory and at least one processor, coupled to the memory, and operative to perform operations comprising accessing a sample batch; computing a conditioning based on given constraints; computing a dense relaxation based on the computed conditioning and the sample batch to generate kernels for conditioning a diffusion optimization model 616; selecting a sample from the sample batch based on a randomly sampled timestep and sampling random noise from a Gaussian distribution; sampling, based on the randomly sampled timestep, a noisy representation of the selected sample based on the sampled random noise; running the diffusion optimization model 616 in a forward direction using the noisy representation of the selected sample to generate a prediction; computing an error loss to minimize an error between the prediction and a target, where the target is the sampled random noise; computing a diffusion optimization loss based on the error loss; and updating the diffusion optimization model 616 based on the diffusion optimization loss using backpropagation.

In one example embodiment, a trajectory alignment is performed to move a sampling path toward an optimization path based on the prediction and the target.

In one example embodiment, the trajectory alignment is performed during training based on a marginalization property of the diffusion optimization model 616, wherein the performing of the trajectory alignment 612 aligns a sampling trajectory of the diffusion optimization model 616 with an optimization trajectory.

In one example embodiment, the performing of the trajectory alignment further comprises performing cycle consistency 404 by matching intermediate sampling steps with intermediate optimization steps to align generated candidate configurations with optimized configurations corresponding to the intermediate optimization steps.

In one example embodiment, the performing of the trajectory alignment further comprises performing consistency regularization 412 by projecting intermediate sampling steps using an auxiliary model in a different functional space and wherein the performing the trajectory alignment in the functional space is related to a performance of a topology where the performance for a generated intermediate design is matched with a ground truth intermediate performance for, the optimized xₛ₍ₜ₋₁₎^{opt}.

In one example embodiment, the trajectory alignment 612 comprises a search phase and a matching phase, wherein a goal of the search phase is to find a closest trajectory, among a set of trajectories that can be represented by a reverse process, to the optimization trajectory, by identifying a representation over a trajectory that aligns with an optimization process.

In one example embodiment, the trajectory alignment search phase comprises leveraging the marginalization properties of the diffusion optimization model 616 as a parametric guide to search for the representation for alignment.

In one example embodiment, the trajectory alignment matching phase further comprises matching a distribution of matching representations for a sampling step t with a distribution of optimized representations at iteration s, wherein the iteration s corresponds to sampling step t−1, conditioned on an optimizer S.

In one example embodiment, the trajectory alignment 612 further comprises performing matching in noisy spaces using a marginal posterior to obtain a noisy optimized representation for a sampling step t−1 and optimizing a noisy trajectory alignment loss function.

In one example embodiment, the trajectory alignment 612 further comprises performing consistency regularization 412 by performing, leveraging an auxiliary model, matching in a performance space and wherein the performing the trajectory alignment is performed in a functional space, wherein a performance for a generated intermediate design is matched with a ground truth intermediate performance Pₛ₍ₜ₋₁₎ for an optimized xₛ₍ₜ₋₁₎^{opt}.

In one example embodiment, the dense relaxation is an approximation method that generates a dense field from sparse input.

In one example embodiment, generated candidate configurations are refined using iterations of optimization.

In one example embodiment, the refining of the generated candidate configurations employs a density field to model material properties, where a corresponding density indicates a proportion of material present in a particular region and where the density field is iteratively adjusted based on the generated constraints.

In one example embodiment, training data is encoded using an auxiliary model to provide consistency regularization 412.

In one example embodiment, optimized topologies X₀, constraints C, volume fractions (VF), and intermediate optimization steps X^{opt} are obtained.

In one example embodiment, a use of a material structure with known load and constraints is optimized, using the updated diffusion optimization model 616, to obtain a resulting design of a structural member for the structure; a three-dimensional solid modeling of the structural member is performed; points defining the shape of the structural member are sent to a computer-controlled three-dimensional printer; and a prototype of the resulting design is created with the computer-controlled three-dimensional printer.

Refer now to FIG. 11.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as machine learning system 200 embodying aspects of the invention. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 11. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on. EUD 103 is also generally representative of a computer-controlled machine tool, or the like.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
accessing a sample batch;
computing a conditioning based on given constraints;
computing a dense relaxation based on the computed conditioning and the sample batch to generate kernels for conditioning a diffusion optimization model;
selecting a sample from the sample batch based on a randomly sampled timestep and sampling random noise from a Gaussian distribution;
sampling, based on the randomly sampled timestep, a noisy representation of the selected sample based on the sampled random noise;
running the diffusion optimization model in a forward direction using the noisy representation of the selected sample to generate a prediction;
computing an error loss to minimize an error between the prediction and a target, where the target is the sampled random noise;
computing a diffusion optimization loss based on the error loss; and
updating the diffusion optimization model based on the diffusion optimization loss using backpropagation.

2. The computer-implemented method of claim 1, further comprising performing a trajectory alignment to move a sampling path toward an optimization path based on the prediction and the target.

3. The computer-implemented method of claim 2, wherein the trajectory alignment is performed during training based on a marginalization property of the diffusion optimization model, wherein the performing of the trajectory alignment aligns a sampling trajectory of the diffusion optimization model with an optimization trajectory.

4. The computer-implemented method of claim 3, wherein the performing of the trajectory alignment further comprises performing cycle consistency by matching intermediate sampling steps with intermediate optimization steps to align generated candidate configurations with optimized configurations corresponding to the intermediate optimization steps.

5. The computer-implemented method of claim 3, wherein the performing of the trajectory alignment further comprises performing consistency regularization by projecting intermediate sampling steps using an auxiliary model in a different functional space and wherein the performing the trajectory alignment in the functional space is related to a performance of a topology where the performance for a generated intermediate design is matched with a ground truth intermediate performance for the optimized xₛ₍ₜ₋₁₎^{opt}.

6. The computer-implemented method of claim 3, wherein the trajectory alignment comprises a search phase and a matching phase, wherein a goal of the search phase is to find a closest trajectory, among a set of trajectories that can be represented by a reverse process, to the optimization trajectory, by identifying a representation over a trajectory that aligns with an optimization process.

7. The computer-implemented method of claim 6, wherein the trajectory alignment search phase comprises leveraging the marginalization properties of the diffusion optimization model as a parametric guide to search for the representation for alignment.

8. The computer-implemented method of claim 7, wherein the trajectory alignment matching phase further comprises matching a distribution of matching representations for a sampling step t with a distribution of optimized representations at iteration s, wherein the iteration s corresponds to sampling step t−1, conditioned on an optimizer S.

9. The computer-implemented method of claim 3, wherein the trajectory alignment further comprises performing matching in noisy spaces using a marginal posterior to obtain a noisy optimized representation for a sampling step t−1 and optimizing a noisy trajectory alignment loss function.

10. The computer-implemented method of claim 3, wherein the trajectory alignment further comprises performing consistency regularization by performing, leveraging an auxiliary model, matching in a performance space and wherein the performing the trajectory alignment is performed in a functional space, wherein a performance for a generated intermediate design is matched with a ground truth intermediate performance Pₛ₍ₜ₋₁₎ for an optimized xₛ₍ₜ₋₁₎^{opt}.

11. The computer-implemented method of claim 1, wherein the dense relaxation is an approximation method that generates a dense field from sparse input.

12. The computer-implemented method of claim 1, further comprising refining generated candidate configurations using iterations of optimization.

13. The computer-implemented method of claim 12, wherein the refining of the generated candidate configurations employs a density field to model material properties, where a corresponding density indicates a proportion of material present in a particular region and further comprising iteratively adjusting the density field based on the generated constraints.

14. The computer-implemented method of claim 1, further comprising encoding training data using an auxiliary model to provide consistency regularization.

15. The computer-implemented method of claim 1, further comprising obtaining optimized topologies X₀, constraints C, volume fractions (VF), and intermediate optimization steps X^{opt}.

16. The computer-implemented method of claim 1, further comprising:
optimizing, using the updated diffusion optimization model, a use of a material structure with known load and constraints to obtain a resulting design of a structural member for the structure;
performing a three-dimensional solid modeling of the structural member;
sending points defining the shape of the structural member to a computer-controlled three-dimensional printer; and
creating a prototype of the resulting design with the computer-controlled three-dimensional printer.

17. A computer program product, comprising:
one or more tangible computer-readable storage media and program instructions stored on at least one of the one or more tangible computer-readable storage media, the program instructions executable by a processor, the program instructions comprising:
accessing a sample batch;
computing a conditioning based on given constraints;
computing a dense relaxation based on the computed conditioning and the sample batch to generate kernels for conditioning a diffusion optimization model;
selecting a sample from the sample batch based on a randomly sampled timestep and sampling random noise from a Gaussian distribution;
sampling, based on the randomly sampled timestep, a noisy representation of the selected sample based on the sampled random noise;
running the diffusion optimization model in a forward direction using the noisy representation of the selected sample to generate a prediction;
computing an error loss to minimize an error between the prediction and a target, where the target is the sampled random noise;
computing a diffusion optimization loss based on the error loss; and
updating the diffusion optimization model based on the diffusion optimization loss using backpropagation.

18. A system comprising:
a memory; and
at least one processor, coupled to the memory, and operative to perform operations comprising:
accessing a sample batch;
computing a conditioning based on given constraints;
computing a dense relaxation based on the computed conditioning and the sample batch to generate kernels for conditioning a diffusion optimization model; selecting a sample from the sample batch based on a randomly sampled timestep and sampling random noise from a Gaussian distribution;
sampling, based on the randomly sampled timestep, a noisy representation of the selected sample based on the sampled random noise;
running the diffusion optimization model in a forward direction using the noisy representation of the selected sample to generate a prediction;
computing an error loss to minimize an error between the prediction and a target, where the target is the sampled random noise;
computing a diffusion optimization loss based on the error loss; and
updating the diffusion optimization model based on the diffusion optimization loss using backpropagation.

19. The system of claim 18, the operations further comprising performing a trajectory alignment to move a sampling path toward an optimization path based on the prediction and the target.

20. The system of claim 19, wherein the trajectory alignment is performed during training based on a marginalization property of the diffusion optimization model, wherein the performing of the trajectory alignment aligns a sampling trajectory of the diffusion optimization model with an optimization trajectory.
